(19) United States
(12) Patent Application Publication
(10) Pub. No.: US 2025/0392892 A1
(43) Pub. Date: Dec. 25, 2025

(54) OPERATION OF AMBIENT INTERNET OF THINGS (AIOT) DEVICES

(71) Applicant: Lenovo (United States) Inc., Morrisville, NC (US)

(72) Inventor: Hyung-Nam CHOI, Ottobrunn (DE)

(21) Appl. No.: 19/307,492

(22) Filed: Aug. 22, 2025

(51) Int. Cl. H04W 4/70; H04W 52/02

(52) U.S. Cl. CPC H04W 4/70; H04W 52/0274

(57) ABSTRACT

Various aspects of the present disclosure relate to operating ambient Internet of Things (AIoT) devices based on their capabilities and/or associated target applications. For example, an AIoT device may receive a message from a reader device, switch operation states upon receiving the message, and perform an AIoT operation (e.g., an inventory or command procedure) after switching operation states. The reader device may initiate the switching of an AIoT device to a supported operation state for performing a requested AIoT operation, facilitating a targeted operation of the AIoT device for a specific or associated application.

### TECHNICAL FIELD

The present disclosure relates to wireless communications, and more specifically to managing (e.g., operating, handling) ambient Internet of Things (AIoT) devices.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like)) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-advanced (5G-A), sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems for managing (e.g., operating) AIoT devices, such as performing IoT operations (e.g., command and/or inventory procedures) in response to and/or based at least in part on switching (e.g., changing) operation states of the IoT devices.

A UE for wireless communication is described. The UE may be configured to, capable of, or operable to perform one or more operations as described herein. For example, the UE may comprise one or more memories and one or more processors coupled with the one or more memories and individually or collectively configured to cause the UE to receive a first message associated with performance of an AIoT operation associated with an operation mode supported by the UE, switch from a first operation state associated with the AIoT operation to a second operation state associated with the AIoT operation in response to the received first message, and perform the AIoT operation in accordance with the second operation state based at least in part on the switching.

A processor for wireless communication is described. The processor may be configured to, capable of, or operable to perform one or more operations as described herein. For example, the processor may comprise one or more memories and one or more controllers coupled with the one or more memories and individually or collectively configured to cause the processor to receive a first message associated with performance of an AIoT operation associated with an operation mode supported by the UE, switch from a first operation state associated with the AIoT operation to a second operation state associated with the AIoT operation in response to the received first message, and perform the AIoT operation in accordance with the second operation state based at least in part on the switching.

A method performed or performable by the UE is described. The method may comprise receiving a first message associated with performance of an AIoT operation associated with an operation mode supported by the UE, switching from a first operation state associated with the AIoT operation to a second operation state associated with the AIoT operation in response to the received first message, and performing the AIoT operation in accordance with the second operation state based at least in part on the switching.

In some implementations of the UE, processor, and method described herein, to switch from the first operation state associated with the AIoT operation to the second operation state associated with the AIoT operation, the UE, processor, and method may further be configured to, capable of, performed, performable, or operable to set a state variable for the second operation state.

In some implementations of the UE, processor, and method described herein, a device identifier of the UE includes the operation mode supported by the UE.

In some implementations of the UE, processor, and method described herein, the operation mode includes an inventory-only mode, a command-only mode, or an inventory and command mode.

In some implementations of the UE, processor, and method described herein, the first operation state and the second operation state include a power ON operation state, an inventory operation state, a command operation state, or a disable operation state.

In some implementations of the UE, processor, and method described herein, the UE, processor, and method may further be configured to, capable of, performed, performable, or operable to set a timer associated with the second operation state and switch to a power OFF state based at least in part on an expiry of the timer associated with the second operation state.

In some implementations of the UE, processor, and method described herein, a duration of the timer is based at least in part on the second operation state and an energy storage level of the UE.

In some implementations of the UE, processor, and method described herein, the first message is a reader to device (R2D) command message or an R2D inventory message.

In some implementations of the UE, processor, and method described herein, the UE, processor, and method may further be configured to, capable of, performed, performable, or operable to transmit a second message in response to the performed AIoT operation and switch from the second operation state associated with the AIoT operation to a third operation state associated with the AIoT operation in response to the transmitted second message.

In some implementations of the UE, processor, and method described herein, the UE is an AIoT device.

A reader device for wireless communication is described. The reader device may be configured to, capable of, or operable to perform one or more operations as described herein. For example, the reader device may comprise one or more memories and one or more processors coupled with the one or more memories and individually or collectively configured to cause the reader device to receive an operation request message that includes a target area and a device identifier for an AIoT device within the target area, wherein the device identifier includes information associated with one or more operation modes supported by the AIoT device and transmit, to an AIoT device associated with the identifier, a message associated with performance of an AIoT operation associated with the one or more operation modes supported by the AIoT device.

A method performed or performable by the reader device is described. The method may comprise receiving an operation request message that includes a target area and a device identifier for an AIoT device within the target area, wherein the device identifier includes information associated with one or more operation modes supported by the AIoT device and transmitting, to an AIoT device associated with the identifier, a message associated with performance of an AIoT operation associated with the one or more operation modes supported by the AIoT device.

In some implementations of the reader device and method described herein, the one or more operation modes include an inventory-only mode, a command-only mode, or an inventory and command mode.

In some implementations of the UE, processor, and method described herein, the reader device is a radio access network (RAN) node and the message is a reader to device (R2D) command message or an R2D inventory message.

In some implementations of the UE, processor, and method described herein, the identification information of the device identifier includes an operation mode identifier for the one or more operation modes supported by the AIoT device.

In some implementations of the UE, processor, and method described herein, the domain information of the device identifier includes an operation mode identifier for the one or more operation modes supported by the AIoT device.

### BRIEF DESCRIPTION OF THE DRAWINGS

FIG. 1 illustrates an example of a wireless communications system in accordance with aspects of the present disclosure.

FIGS. 2A-2B illustrate example topologies for AIoT devices in accordance with aspects of the present disclosure.

FIG. 3A-3B illustrate example deployment scenarios for reader devices and AIoT devices in accordance with aspects of the present disclosure.

FIG. 4 illustrates an example device identifier for an AIoT device in accordance with aspects of the present disclosure.

FIGS. 5A-5B illustrate messaging flows for performing IoT operations in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a NE in accordance with aspects of the present disclosure.

FIG. 9 illustrates a flowchart of a method performed by a UE in accordance with aspects of the present disclosure.

FIG. 10 illustrates a flowchart of a method performed by a reader device in accordance with aspects of the present disclosure.

### DETAILED DESCRIPTION

A wireless communications system may include one or more IoT devices, which may be an AIoT device, a passive-IoT device, and/or a passive radio frequency identification (RFID) tag (e.g., sticker, tag, badge, patch, or the like) that supports one or more functionalities at lower cost, complexity, and/or maintenance compared to other devices. For example, an AIoT device may harvest and store energy from an environment, such as one or more of solar (e.g., via photovoltaic energy harvesting), vibration (e.g., via piezoelectric, electrostatic, or electromagnetic energy harvesting), thermal (e.g., via thermoelectric energy harvesting), or radio waves, such as radio frequency (e.g., via signals received through an antenna of the AIoT device). Thus, an AIoT device may be any device that is ambient power-enabled, such as battery-less devices or devices with limited storage capabilities (e.g., devices that store a limited amount of energy using capacitors) or other restricted or limited capabilities.

A network node, such as a UE or an NE (e.g., a base station) may operate as a reader device that interacts with AIoT devices. For example, a network node configured or operating as a reader device may transmit a carrier wave to an AIoT device to excite (e.g., activate) the AIoT device to perform backscattering transmissions or other communications, or communicate a message to an AIoT device during device selection procedures, or may read or receive the backscattering transmissions. The network node may interact with various network functions, such as an AIoT function (AIOTF) that communicates directly with the network node and/or an application function (AF) that communicates with the network node via the AIOTF.

The AIoT device may perform one or more operations (e.g., transmission, reception, via backscattering) using the stored harvested energy. For example, the AIoT device may be a passive RFID tag equipped on an object or other device enabling for tracking of a location of the object or the other device using stored harvested energy. Example use cases or IoT operations (e.g., AIoT operations) performed by AIoT devices (e.g., one or multiple) include inventory taking (e.g., tracking and/or acknowledgement of a presence of an object) and/or command procedures (e.g., read, write, control, enable, disable, and so on), sensor data collection, asset tracking, actuator control, and so on.

In some cases, an AIoT device (or a group of AIoT devices) may exclusively support a subset of functionalities or operations. For example, an AIoT device may be deployed or provisioned for a specific application (e.g., the tracking of objects) and thereby support operations (e.g., inventory taking, not command procedures) associated with that specific application. Further, the use of AIoT devices may expand or be extended, where AIoT devices are deployed in new scenarios (e.g., an outdoor deployment scenario where a command procedure is performed without a previous inventory procedure). Thus, issues may arise associated with the provisioning of AIoT devices to target applications.

The present disclosure introduces methods for managing (e.g., operating) AIoT devices based on capabilities of the AIoT devices and/or associated target applications associated with the AIoT devices. For example, an AIoT device may receive a message from a reader device (e.g., a network node), switch operation states in response to and/or based at least in part on receiving the message, and perform an AIoT operation (e.g., an inventory or command procedure) in response to and/or based at least in part on switching operation states.

Thus, a reader device may initiate the switching for an AIoT device to a supported operation state for performing a requested AIoT operation, facilitating a targeted operation of the AIoT device for a specific or associated application, among other benefits. Further, associated network nodes (e.g., the AIOTF) may be able to implement a simple and controlled operation mechanism for deployed AIoT devices and/or may have knowledge of their behaviors, among other benefits. In addition, In being managed to switch between operation states, an AIoT device may perform AIoT operations in a more efficient and/or power saving, fashion, among other benefits.

Aspects of the present disclosure are described in the context of a wireless communications system.

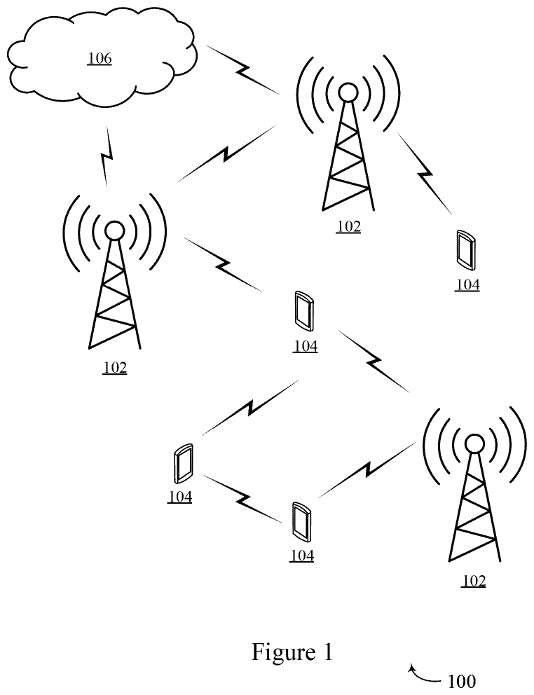

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be an NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signaling bearers, etc.) for the one or more UEs 104 served by the one or more NE 102 associated with the CN 106.

The CN 106 may communicate with a packet data network over one or more backhaul links (e.g., via an S1, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The wireless communications system 100 may support managing (e.g., controlling, configuring) operation of IoT devices (e.g., which may be an example of a UE 104), such as AIoT devices. As described herein, an AIoT device may be associated with a low complexity profile (e.g., low power consumption, less capabilities) and/or be implemented as an ambient-power enabled ultra-low complexity device with ultra-low power consumption.

An AIoT device may be classified according to one or more categories. A first category AIoT device may lack both energy harvesting capabilities and communication capabilities. As such, the first category AIoT device may be exclusively capable of performing backscattering operations (e.g., backscattering transmissions). A second category AIoT device may support energy harvesting capabilities but lack communication capabilities. As such, the second category AIoT device may be exclusively capable of performing backscattering operations (e.g., backscattering transmissions). However, in some cases, because the second category AIoT device supports energy harvesting capabilities, the second category AIoT device may be capable of amplifying reflected signals using stored harvested energy. A third category AIoT device may support both energy harvesting and communication capabilities. In this example, the third category AIoT device may be equipped with an active radio frequency circuitry to support active communication (e.g., transmission, reception of signals).

In some implementations, the wireless communications system 100 may implement various topologies and deployment scenarios, such as an example topology in which an NE (e.g., a base station or other network entity) functions as a reader (e.g., a reader device) and a source of a carrier wave (e.g., for exciting an AIoT device to perform backscattering), another example topology in which the NE functions as the reader and a different device (e.g., a UE) functions as the source of the carrier wave, another example topology in which the NE controls operations and the UE (e.g., the UE 104) or other network entities (e.g., nodes) function as readers and/or carrier wave sources, and the like.

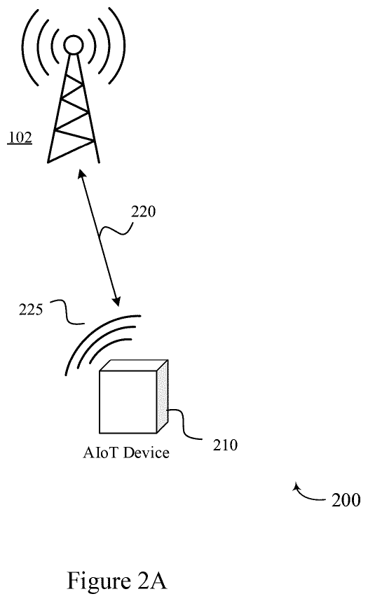

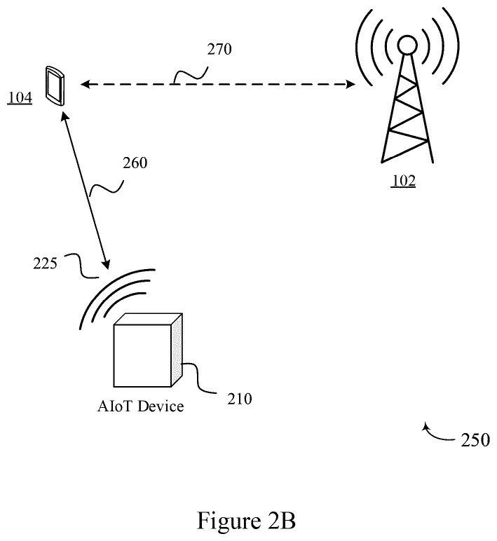

FIG. 2A illustrates an example topology 200 for AIoT devices in accordance with aspects of the present disclosure. In some examples, the topology 200 may implement or be implemented by aspects of the wireless communications system 100. For example, the topology 200 may be implemented by an NE and/or a UE, which may be an example of an NE 102 and a UE 104 as described with reference to FIG. 1. In the example of FIG. 2A, an AIoT device 210, which may be an example of a UE 104 as described with reference to FIG. 1, may directly and bidirectionally communicate with the NE 102. The NE 102 may provide communication coverage via one or more cells, for example a macro cell, a small cell, a micro cell, or other types of cells, or any combination thereof. A communication link 220 between the NE 102 and the AIoT device 210 may support communication (e.g., transfer, transmission, reception, etc.) of AIoT data (e.g., via backscattering 225) and/or other signaling (e.g., control information, data). In an example implementation, both the AIoT device 210 and the NE 102 are located indoors (with a micro cell being part of a group of cells or NEs 102).

FIG. 2B illustrates an example topology 250 for AIoT devices in accordance with aspects of the present disclosure. In some examples, the topology 250 may implement or be implemented by aspects of the wireless communications system 100. For example, the topology 250 may be implemented by an NE and/or a UE, which may be an example of an NE 102 and a UE 104 as described with reference to FIG. 1. In the example of FIG. 2B, a UE 104, or another network node, may act (e.g., function, operate) as an intermediate node between an NE 102 and an AIoT device 210. For example, the UE 104 may function as an emitter and/or reader, where the UE 104 sends (e.g., outputs, transmits) carrier waves to the AIoT device 210, which excite (e.g., activate) the AIoT device 210, enabling or causing the AIoT device 210 to perform the backscattering transmissions 225, which may be received and read (e.g., demodulated, decoded) by the UE 104.

The AIoT device 210 may directly and bidirectionally communicate with the UE 104 (e.g., which may relay data to the NE 102, serving a macro cell). A communication link 260 between the UE 104 and the AIoT device 210 and/or a link 270 between the UE 104 and the NE 102 may support communication (e.g., transfer, transmission, reception, etc.) of AIoT data (e.g., via backscattering 225) and/or other signaling (e.g., control information, data). In an example implementation, the AIoT device 210 and the UE 104 are both located indoors, and the NE 102 is located outdoors (with the macro cell being part of a group of cells or NEs 102).

The AIoT device 210 may communicate with the intermediate node (e.g., the UE 104 or another network node) and/or the network (e.g., via the NE 102) using a reduced set of components (e.g., protocol layers, circuitry, hardware). For example, the AIoT device 210 may be an IoT device of ultra-low complexity with ultra-low power consumption (e.g., sufficient for low-end IoT applications), having a radio protocol stack architecture that is comparatively compact with respect to typical NR architectures for communication devices.

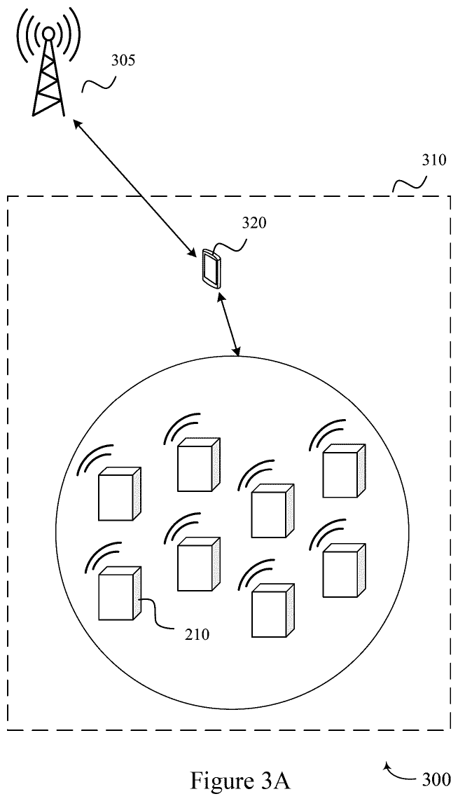

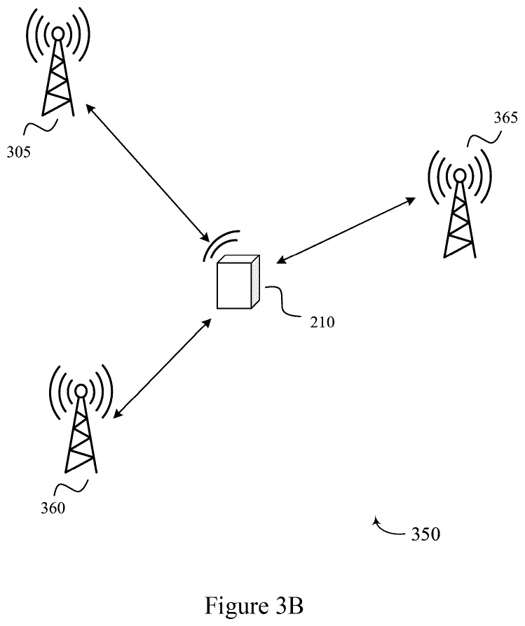

FIG. 3A illustrates an example deployment scenario 300 for a reader device and associated AIoT devices in accordance with aspects of the present disclosure. In some examples, the deployment scenario 300 may implement or be implemented by aspects of the wireless communications system 100. For example, the deployment scenario 300 may be implemented by an NE (e.g., a base station) and/or a UE, which may be an example of an NE 102 and a UE 104 as described with reference to FIG. 1.

In the example of FIG. 3A, a location 310, or target area (e.g., a warehouse or other indoor facility), may be served by a base station 305 in communication with (e.g., serving) a UE 320, or other network node, deployed and/or positioned as a reader device with respect to one or mulitple AIoT devices 210 (e.g., 100 or more AIoT devices). The UE 320 may be a stationary reader device (e.g., a device fixed or installed to one location within the location 310), a mobile reader device (e.g., a device that moves within the location 310), and so on.

In some cases, various IoT operations (e.g., AIoT operations), such as inventory or command procedures, may be assigned or associated with one or more of the AIoT devices 210. For example, the base station 305 may perform a first AIoT operation (e.g., an inventory-only operation) using one or a first subset of the AIoT devices 210 and perform a second AIoT operation (e.g., an inventory and command operation) using another or a second subset of the AIoT devices 210.

FIG. 3B illustrates another example deployment scenario 350 in accordance with aspects of the present disclosure. In some examples, the deployment scenario 350 may implement or be implemented by aspects of the wireless communications system 100. For example, the deployment scenario 350 may be implemented by an NE (e.g., a base station) and/or a UE, which may be an example of an NE 102 and a UE 104 as described with reference to FIG. 1.

In the example of FIG. 3B, a single AIoT device 210 may be located in a service area or location that is served by multiple network nodes, for example, a base station 305, a base station 360, and a base station 365, each functioning (e.g., acting, operating) as reader devices (e.g., for a RAN node, such as an AIoT RAN node).

As described herein, the wireless communications system 100 may facilitate the operation of AIoT devices based on capabilities of the AIoT devices and/or applications associated with the AIoT devices. As described herein, each of the AIoT devices 210 may be capable of supporting one or more operation modes, including inventory-only (e.g., only performing an inventory taking procedure), command-only (e.g., only performing a command procedure), inventory and command (e.g., performing both procedures), or others not yet defined. For example, a smart tag may exclusively be capable of performing the inventory-only mode. In some examples, a device identifier for the AIoT device 210 may encode or otherwise include the operation mode or modes that are supported by the AIoT device 210.

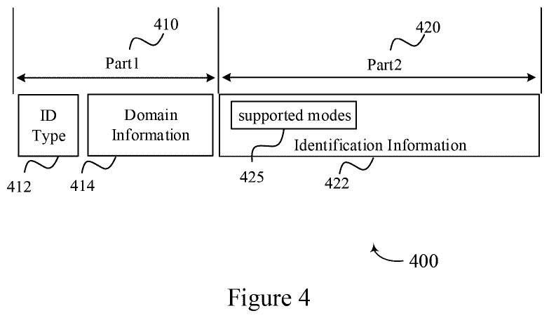

FIG. 4 illustrates an example device identifier 400 for an AIoT device in accordance with aspects of the present disclosure. In some examples, the device identifier 400 may implement or be implemented by aspects of the wireless communications system 100. For example, the device identifier 400 may be implemented by an NE (e.g., a base station) and/or a UE (e.g., an AIoT device), which may be an example of an NE 102 and a UE 104 as described with reference to FIG. 1.

The device identifier 400 may include, in Part1 information 410, which has a fixed size, an ID type 412 and domain information 414. The ID type 412 may include: information indicating whether a public land mobile network (PLMN) ID is included, information indicating whether a network identifier (NID) is included, information indicating whether a third party identifier is included, information indicating whether an electronic product code (EPC) or unstructured information is included, and so on. The domain information 414 may include the PLMN ID (e.g., a mobile country code (MCC) and mobile network code (MNC)), a NID, a third party identifier, and so on.

The device identifier 400 may also include Part2 information 420, which has a flexible size. The Part2 information 420 may include identification information, which can distinguish different AIoT devices based on the domain information 414 and may include an EPC or unstructured information. The Part2 information 420 may also include supported modes information 425 that indicates or identifies the supported modes for the AIoT device. In some cases, the supported modes information 425 may be a new information type within the device identifier 400.

An AIoT device (e.g., the AIoT devices 210) may move between different operation states based on its supported operation mode. Example operation states include:
Power OFF, a state in which an AIoT device enters when it runs out of energy and/or harvests energy;
Power ON, a state in which an AIoT device has harvested or has stored sufficient energy to enable communications with other devices (e.g., a reader device);
Inventory, a state in which an AIoT device has been selected for an inventory procedure;
Command, a state in which an AIoT device has received a command message;
Disable, a state in which an AIoT device has sent a permanent disable command response message (to a reader device). In a disable state, the AIoT device cannot transmit RF signals, although it can receive RF signals (e.g., but not respond to any R2D message); and so on.

As a first example, during an inventory and command procedure, an AIoT device may transition (e.g., perform a state transition) between the different operation states (e.g., power OFF, power ON, inventory, command, and disable). The AIoT device may perform a state transition from the command state to the power ON, power OFF, or disable state and/or perform a state transition from the inventory state to the power OFF state or the power ON state (e.g., a two-way state transition).

As a second example, during an inventory-only procedure, an AIoT device may transition between the inventory, power OFF, and power ON states. The AIoT device may perform a state transition from the inventory state to the power OFF state and/or the power ON state (e.g., a two-way state transition).

As a third example, during a command-only procedure, an AIoT device may transition between the command, power OFF, power ON, and disable states. The AIoT device may perform a state transition from the command state to the power OFF state, the disable state, and/or the power ON state (e.g., a two-way state transition). Of course, the AIoT device, during any operation mode, may perform a two-way state transition between the power ON and power OFF states.

Transitions between the different operation states may be controlled by R2D messages received from a reader device and/or based on a current energy storage level of the AIoT device. For example, the AIoT device 210 may act only on a defined set of R2D messages that are received from a reader device and/or may only transmit a defined set of D2R messages to the reader device.

In some cases, when an AIoT device enters an operation state, the AIoT device stores a current state in a state variable (e.g., “Current_state”) and stores a potential (e.g., candidate) next operation state (or states) in a state variable (e.g., “Next_state”). Table 1 provides example state variables for an inventory and command procedure.

TABLE 1

| Variable | Variable | |
|---|---|---|
| “Current_state” | “Next_state” | Condition |
| Power-off | Power-On | The AIoT device has harvested |
| | | sufficient energy that enables the |
| | | AIoT device to communicate with |
| | | the reader. |
| Power-on | Power-off | The AIoT device runs out of energy. |
| | Inventory | The AIoT device has been selected |
| | | by the reader for an inventory |
| | | procedure. |
| | Command | The AIoT device has received a |
| | | command message from the reader. |
| Inventory | Power-Off | The AIoT device runs out of energy. |
| | Power-On | The AIoT device has successfully |
| | | completed the inventory procedure |
| | | by sending an inventory response |
| | | message to the reader. |
| Command | Power-Off | The AIoT device runs out of energy. |
| | Power-On | The AIoT device has successfully |
| | | completed the command procedure |
| | | by sending a command response |
| | | message to the reader. |
| | Disable | The AIoT device has sent a |
| | | permanent disable command response |
| | | message to the reader. |
| Disable | N/A | Once permanently disabled the AIoT |
| | | device stays in this state. |

Table 2 provides example state variables for an inventory-only procedure.

TABLE 2

| Variable | Variable | |
|---|---|---|
| “Current_state” | “Next_state” | Condition |
| Power-off | Power-On | The AIoT device has harvested |
| | | sufficient energy that enables the |
| | | AIoT device to communicate with the |
| | | reader. |
| Power-on | Power-off | The AIoT device runs out of energy. |
| | Inventory | The AIoT device has been selected |
| | | by the reader for an inventory |
| | | procedure. |
| Inventory | Power-Off | The AIoT device runs out of energy. |
| | Power-On | The AIoT device has successfully |
| | | completed the inventory procedure |
| | | by sending an inventory response |
| | | message to the reader. |

Table 3 provides example state variables for a command-only procedure.

TABLE 3

| Variable | Variable | |
|---|---|---|
| “Current_state” | “Next_state” | Condition |
| Power-off | Power-On | The AIoT device has harvested |
| | | sufficient energy that enables the |
| | | AIoT device to communicate with |
| | | the reader. |
| Power-on | Power-off | The AIoT device runs out of energy. |
| | Command | The AIoT device has received a |
| | | command message from the reader. |
| Command | Power-Off | The AIoT device runs out of energy. |
| | Power-On | The AIoT device has successfully |
| | | completed the command procedure |
| | | by sending a command response |
| | | message to the reader. |
| | Disable | The AIoT device has sent a |
| | | permanent disable command response |
| | | message to the reader. |
| Disable | N/A | Once permanently disabled the |
| | | AIoT device stays in this state. |

In some cases, the AIoT device enters an operation state and starts a timer (also referred to as a state retention timer). The timer may be set to a threshold (e.g., maximum or minimum) time value that corresponds to a length of time the AIoT device can remain in the current state, based on a current energy storage level of the AIoT device. Thus, the timer may be based on the operation state and the energy stored by the AIoT device. Alternatively, in some cases, the timer may be based on the operation state or the energy stored by the AIoT device. Upon expiry (e.g., lapsing) of the timer, the AIoT device may leave the current operation state and enter a different operation state (e.g., a power OFF state or another operation state). Using the timer, the AIoT device may function to perform an AIoT operation with respect to its available stored energy, facilitating an efficient performance of the operation, among other benefits.

As described herein, various different AIoT operations or procedures, such as those supported by the deployment scenarios described herein, may implement the technology described herein.

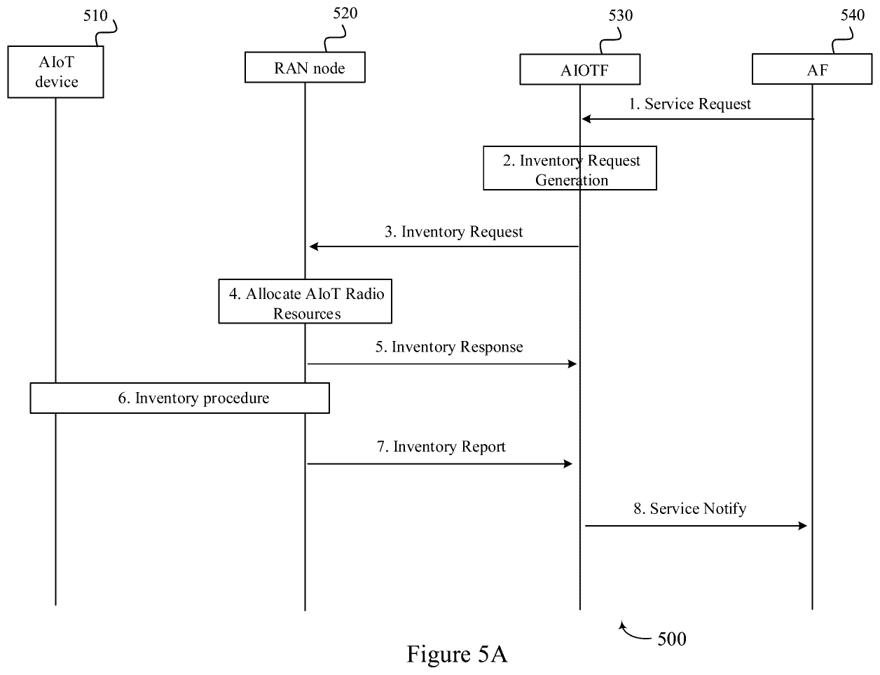

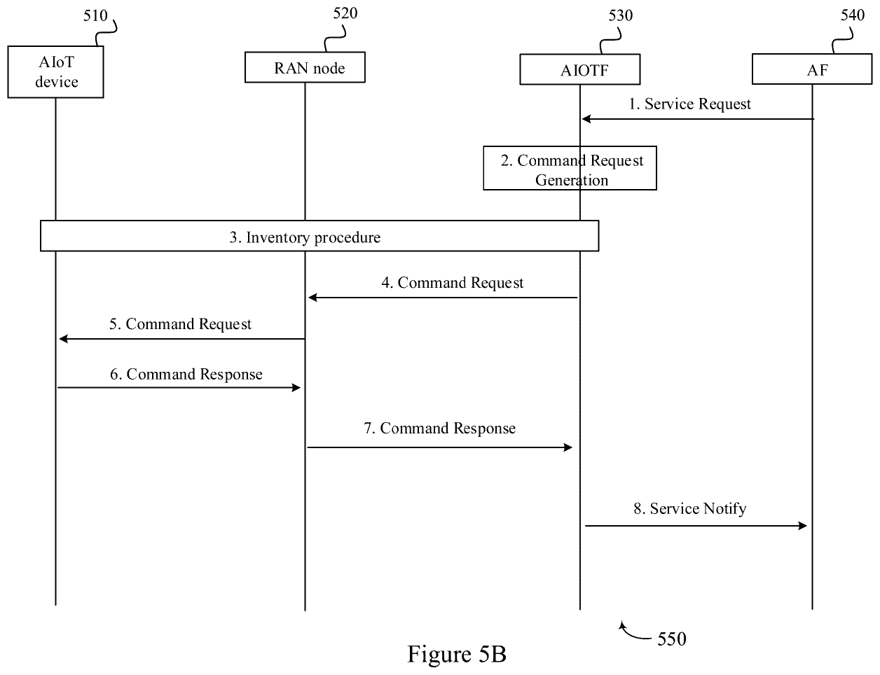

FIG. 5A illustrates a messaging flow 500 for performing an IoT operation in accordance with aspects of the present disclosure. The messaging flow 500 may implement various aspects of the present disclosure described herein. For example, the messaging flow 500 may include an AIoT device 510, a RAN node 520, an AIOTF 530, and an AF 540, which may be examples of AIoT devices, RAN nodes, AIOTFs, and AFs as described herein. In the following description of the messaging flow 500, the operations between the AIoT device 510, the RAN node 520, the AIOTF 530, and the AF 540 may be performed in different orders or at different times. Some operations may also be omitted, or other operations may be added. Although the AIoT device 510, the RAN node 520, the AIOTF 530, and the AF 540 are shown performing the operations of the messaging flow 500, some aspects of some operations may also be performed by other entities of the messaging flow 500 or by entities that are not shown in the messaging flow 500, or any combination thereof.

The messaging flow 500 may facilitate an inventory-only procedure. For example, the AF 540 may request to retrieve an identity of objects (e.g., products or goods) that are located in a service area of a warehouse. The identity of an object (e.g., the device identifier 400) is stored in the memory (e.g., volatile or non-volatile memory, or other memory types) of an AIoT device attached to a target object.

At step 1, the AF 540 sends a service request message to the AIOTF 530. For example, the AF 540 sends a message to retrieve an identity of an object that is located in an area (e.g., a target service area) and to which an AIoT device (e.g., the AIoT device 510) is attached. The service request message may contain information about the area (e.g., the target service area) and the target AIoT device (e.g., the device identifier 400 for the AIoT device 510).

At step 2, the AIOTF 530 generates an inventory request message. For example, in response to and/or based at least in part on reception of the service request message, the AIOTF 530 checks (e.g., analyzes, verifies) parameters included in the service request message, and when the check is completed (e.g., successful verification), generates the inventory request message.

At step 3, the AIOTF 530 sends (e.g., forwards) the inventory request message to the RAN node 520. The RAN node 520 may serve the are (e.g., the target service area) and the target AIoT device 510 as a reader device. The inventory request message may include the AIoT device permanent identifier 400.

At step 4, the RAN node 520 allocates resources for the AIoT for the inventory procedure.

At step 5, the RAN node 520 sends an inventory response message to the AIOTF 530. For example, the inventory response message may indicate that the inventory procedure is initiated or performed with the target AIoT device 510.

At step 6, the RAN node 520 performs the inventory procedure with the target AIoT device 510 over a radio interface (e.g., an AIoT radio interface). The RAN node 520, operating as a reader device, retrieves a stored AIoT device permanent identifier from the target AIoT device 510 in the target service area.

In some cases, the AIoT device 510 receives a paging message containing a paging identifier from the RAN node 520. The AIoT device 510 may be in a power ON operation state when it receives the paging message. The AIoT device 510 determines that the received paging identifier matches the AIoT device permanent identifier stored in its memory (e.g., volatile or non-volatile memory, or other memory types) of the AIoT device 510 and enters an inventory state (e.g., setting a state variable of “Current state” to “Inventory”).

The AIoT device 510 may start a timer (e.g., an associated state retention timer). The timer may be set to a threshold (e.g., maximum or minimum) time value that corresponds to a length of time the AIoT device 510 can maintain remain in a current state based on a current energy storage level of the AIoT device 510. In response to and/or based at least in part on the AIoT device 510 sending a D2R message to the RAN node 520 with an inventory response (e.g., which contains its stored AIoT device permanent identifier), the AIoT device 510 enters a power ON state and sets the state variable “Current state” to “Power-On,” or, if the AIoT device 510 runs out of stored energy, enters the power OFF state.

At step 7, the RAN node 520 sends an inventory report message to the AIOTF 530. For example, after receiving an inventory result (e.g., the AIoT device permanent identifier from the target AIoT device 510), the RAN node 520 sends the inventory report message to the AIOTF 530, which includes the inventory result received from the target AIoT device 510.

At step 8, the AIOTF 530 sends a service notify message to the AF 540. For example, in response to and/or based at least in part on receiving the inventory report message, the AIOTF 530 sends the service notify message to the AF 540, which includes the received AIoT device permanent identifier for the AIoT device 510.

FIG. 5B illustrates a messaging flow 550 for performing an IoT operation in accordance with aspects of the present disclosure. The messaging flow 550 may implement various aspects of the present disclosure described herein. For example, the messaging flow 550 may include an AIoT device 510, a RAN node 520, an AIOTF 530, and an AF 540, which may be examples of AIoT devices, RAN nodes, AIOTFs, and AFs as described herein. In the following description of the messaging flow 550, the operations between the AIoT device 510, the RAN node 520, the AIOTF 530, and the AF 540 may be performed in different orders or at different times. Some operations may also be omitted, or other operations may be added. Although the AIoT device 510, the RAN node 520, the AIOTF 530, and the AF 540 are shown performing the operations of the messaging flow 550, some aspects of some operations may also be performed by other entities of the messaging flow 550 or by entities that are not shown in the messaging flow 550, or any combination thereof.

The messaging flow 550 may facilitate an inventory and command procedure, such as a procedure that employs a contention-based random access (CBRA) procedure.

At step 1, the AF 540 sends a service request message to the AIOTF 530. For example, the AF 540 sends a message to retrieve data from an object that is located in a target service area and to which an AIoT device (e.g., the AIoT device 510) is attached. The service request message may contain information about the target service area, the target AIoT device (e.g., the AIoT device permanent identifier 400 for the AIoT device 510), and the type of data to be retrieved.

At step 2, the AIOTF 530 generates a command request message. For example, in response to and/or based at least in part on reception of the service request message, the AIOTF 530 checks (e.g., verifies) parameters included in the service request message, and when the check is complete (e.g., successful verification), generates the command request message.

At step 3, the RAN node 520 performs the inventory procedure with the target AIoT device 510 over an AIoT radio interface. For example, the RAN node 520, operating as a reader device, retrieves a stored AIoT device permanent identifier from the target AIoT device 510 in the target service area.

As described herein (e.g., via FIG. 5A), the AIoT device 510 receives a paging message containing a paging identifier from the RAN node 520. The AIoT device 510 is in a power ON operation state when it receives (e.g., during reception of) the paging message. The AIoT device 510 determines that the received paging identifier matches the AIoT device permanent identifier stored in its memory (e.g., volatile or non-volatile memory, or other memory types) and enters an inventory state (e.g., setting a state variable of “Current state” to “Inventory”).

The AIoT device 510 may start a timer (also referred to as a state retention timer). For example, the timer may be set to a threshold (e.g., maximum or minimum) time value that corresponds to a length of time the AIoT device 510 can maintain its current state based on its current energy storage level. Once the AIoT device 510 sends a D2R message to the RAN node 520 with an inventory response (e.g., which contains its stored AIoT device permanent identifier), the AIoT device 510 enters a power ON state and sets the state variable “Current_state” to “Power-On,” or, if the AIoT device 510 runs out of stored energy, enters the power OFF state.

At step 4, the AIOTF 530 sends a command request message to the RAN node 520. For example, the command request message may contain the type of data requested from the target AIoT device 510.

At step 5, the RAN node 520, acting as a reader device, sends the command request message to the target AIoT device 510. For example, the RAN node 520 sends, over the AIoT radio interface, the command request message to retrieve the requested data from the target AIoT device 510 in the target service area.

After reception of the command request message, the AIoT device 510 enters the command state and sets a state variable “Current_state” to “Command.” Further, the AIoT device 510 may start a timer (e.g., a state retention timer) with a threshold (e.g., maximum or minimum) time value that corresponds to the length of time the AIoT device 510 can stay in its current state based on its current energy storage level.

At step 6, the AIoT device 510 sends a command response message to the RAN node 520. The command response message may include the requested data from the target AIoT device 510. After sending the command response message, the AIoT device 510 enters the power ON state and sets the associated state variable “Current state” to “Power-On.”

At step 7, the RAN node 520 forwards (e.g., transmits) the received command response message to the AIOTF 530.

At step 8, the AIOTF 530 sends a service notify message to the AF 540. The service notify message includes the requested data from the target AIoT device 510.

Thus, in various implementations, an AIoT device (e.g., the AIoT device 210 or 510) may be configured and/or controlled to transition between operations states when performing AIoT operations and based on its associated operation modes and supported capabilities.

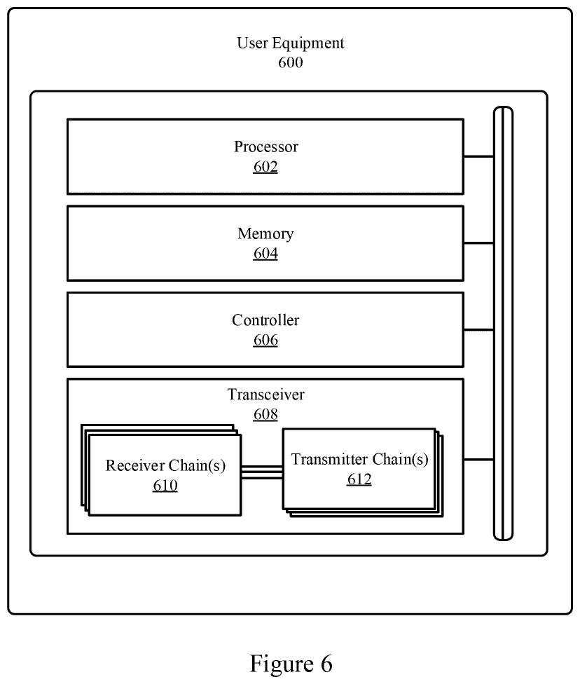

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 (e.g., as an AIoT device) may be configured to support a means for receiving a first message associated with performance of an AIoT operation associated with an operation mode supported by the UE, switching from a first operation state associated with the AIoT operation to a second operation state associated with the AIoT operation in response to the received first message, and performing the AIoT operation in accordance with the second operation state based at least in part on the switching.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

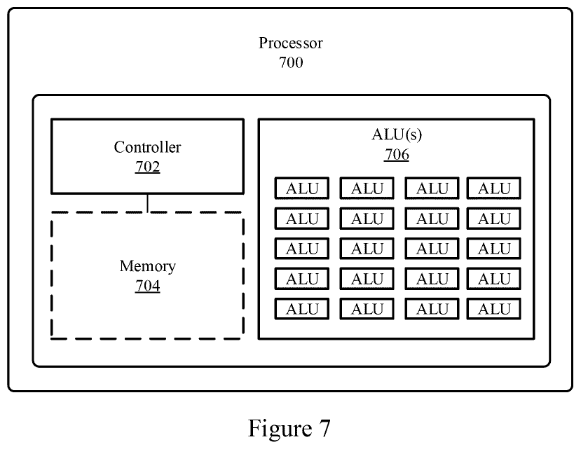

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The UE processor 700 may be configured to support a means for receiving a first message associated with performance of an AIoT operation associated with an operation mode supported by the UE, switching from a first operation state associated with the AIoT operation to a second operation state associated with the AIoT operation in response to the received first message, and performing the AIoT operation in accordance with the second operation state based at least in part on the switching.

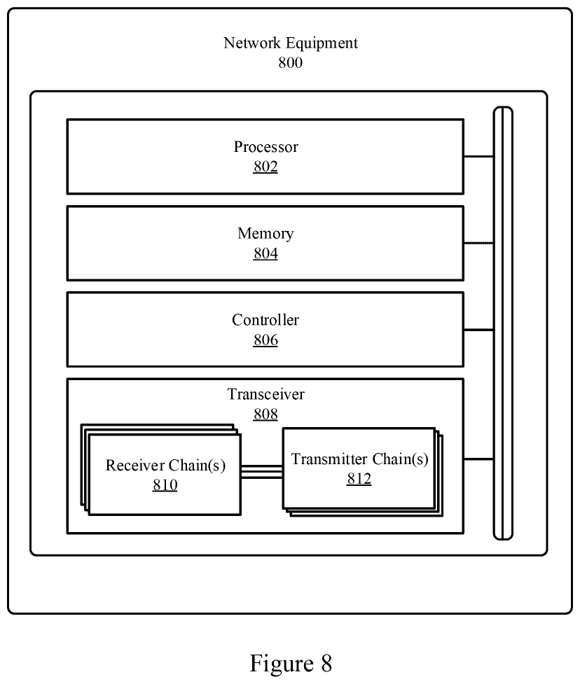

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800, as part of a RAN node, may be configured to support a means for receiving an operation request message that includes a target area and a device identifier for an AIoT device within the target area, wherein the device identifier includes information associated with one or more operation modes supported by the AIoT device and transmitting, to an AIoT device associated with the identifier, a message associated with performance of an AIoT operation associated with the one or more operation modes supported by the AIoT device.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

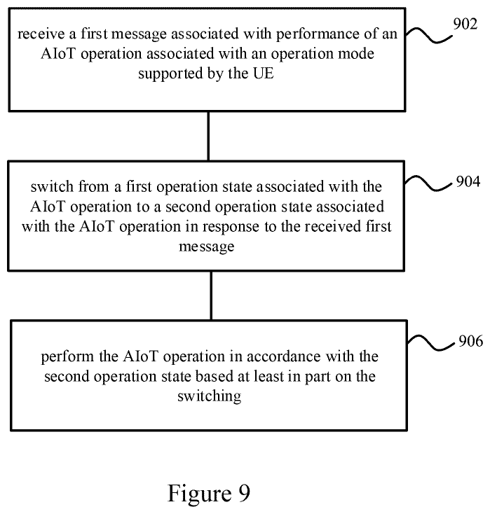

FIG. 9 illustrates a flowchart of a method in accordance with aspects of the present disclosure. The operations of the method may be implemented by a UE (e.g., an AIoT device) as described herein. In some implementations, the UE may execute a set of instructions to control the function elements of the UE to perform the described functions.

At 902, the method may include receiving a first message associated with performance of an AIoT operation associated with an operation mode supported by the UE. The operations of 902 may be performed in accordance with examples as described herein. In some implementations, aspects of the operations of 902 may be performed by a UE as described with reference to FIG. 6.

At 904, the method may include switching from a first operation state associated with the AIoT operation to a second operation state associated with the AIoT operation in response to the received first message. The operations of 904 may be performed in accordance with examples as described herein. In some implementations, aspects of the operations of 904 may be performed by a UE as described with reference to FIG. 6.

At 906, the method may include performing the AIoT operation in accordance with the second operation state based at least in part on the switching. The operations of 906 may be performed in accordance with examples as described herein. In some implementations, aspects of the operations of 906 may be performed by a UE as described with reference to FIG. 6.

It should be noted that the method described herein describes a possible implementation, and that the operations and the steps may be rearranged or otherwise modified and that other implementations are possible.

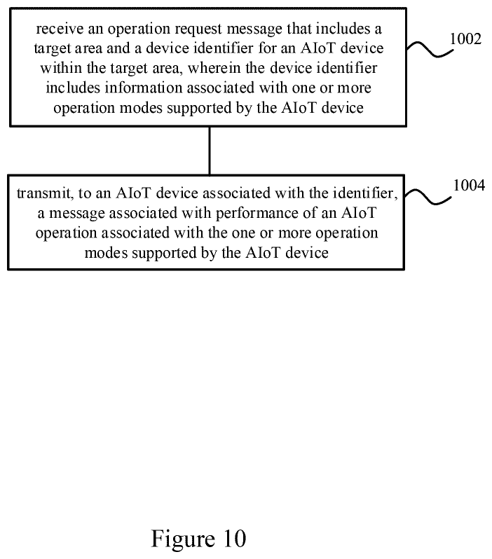

FIG. 10 illustrates a flowchart of a method in accordance with aspects of the present disclosure. The operations of the method may be implemented by a reader device (e.g., an NE or a UE) as described herein. In some implementations, the reader device may execute a set of instructions to control the function elements of the reader device to perform the described functions.

At 1002, the method may include receiving an operation request message that includes a target area and a device identifier for an AIoT device within the target area, wherein the device identifier includes information associated with one or more operation modes supported by the AIoT device. The operations of 1002 may be performed in accordance with examples as described herein. In some implementations, aspects of the operations of 1002 may be performed by an NE as described with reference to FIG. 8.

At 1004, the method may include transmitting, to an AIoT device associated with the identifier, a message associated with performance of an AIoT operation associated with the one or more operation modes supported by the AIoT device. The operations of 1004 may be performed in accordance with examples as described herein. In some implementations, aspects of the operations of 1004 may be performed by an NE as described with reference to FIG. 8.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
one or more memories; and
one or more processors coupled with the one or more memories and individually or collectively configured to cause the UE to:
receive a first message associated with performance of an ambient Internet of Things (AIoT) operation associated with an operation mode supported by the UE;
switch from a first operation state associated with the AIoT operation to a second operation state associated with the AIoT operation in response to the received first message; and
perform the AIoT operation in accordance with the second operation state based at least in part on the switching.

2. The UE of claim 1, wherein, to switch from the first operation state associated with the AIoT operation to the second operation state associated with the AIoT operation, the one or more processors are further individually or collectively configured to cause the UE to set a state variable for the second operation state.

3. The UE of claim 1, wherein a device identifier of the UE includes the operation mode supported by the UE.

4. The UE of claim 1, wherein the operation mode includes an inventory-only mode, a command-only mode, or an inventory and command mode.

5. The UE of claim 1, wherein the first operation state and the second operation state include a power ON operation state, an inventory operation state, a command operation state, or a disable operation state.

6. The UE of claim 1, wherein the one or more processors are further individually or collectively configured to cause the UE to:
set a timer associated with the second operation state; and
switch to a power OFF state based at least in part on an expiry of the timer associated with the second operation state.

7. The UE of claim 6, wherein a duration of the timer is based at least in part on the second operation state and an energy storage level of the UE.

8. The UE of claim 1, wherein the first message is a reader to device (R2D) command message or an R2D inventory message.

9. The UE of claim 1, wherein the one or more processors are further individually or collectively configured to cause the UE to:
transmit a second message in response to the performed AIoT operation; and
switch from the second operation state associated with the AIoT operation to a third operation state associated with the AIoT operation in response to the transmitted second message.

10. The UE of claim 1, wherein the UE is an AIoT device.

11. A reader device for wireless communication, comprising:
one or more memories; and
one or more processors coupled with the one or more memories and individually or collectively configured to cause the reader device to:
receive an operation request message that includes a target area and a device identifier for an ambient Internet of Things (AIoT) device within the target area,
wherein the device identifier includes information associated with one or more operation modes supported by the AIoT device; and
transmit, to an AIoT device associated with the identifier, a message associated with performance of an AIoT operation associated with the one or more operation modes supported by the AIoT device.

12. The reader device of claim 11, wherein the one or more operation modes include an inventory-only mode, a command-only mode, or an inventory and command mode.

13. The reader device of claim 11, wherein the reader device is a radio access network (RAN) node and the message is a reader to device (R2D) command message or an R2D inventory message.

14. The reader device of claim 11, wherein identification information of the device identifier includes an operation mode identifier for the one or more operation modes supported by the AIoT device.

15. The reader device of claim 11, wherein domain information of the device identifier includes an operation mode identifier for the one or more operation modes supported by the AIoT device.

16. A method performed by a user equipment (UE), the method comprising:
receiving a first message associated with performance of an ambient Internet of Things (AIoT) operation associated with an operation mode supported by the UE;
switching from a first operation state associated with the AIoT operation to a second operation state associated with the AIoT operation in response to the received first message; and
performing the AIoT operation in accordance with the second operation state based at least in part on the switching.

17. The method of claim 16, wherein switching from the first operation state associated with the AIoT operation to the second operation state associated with the AIoT operation includes setting a state variable for the second operation state.

18. The method of claim 16, further comprising:
setting a timer associated with the second operation state; and
switching to a power OFF state based at least in part on an expiry of the timer associated with the second operation state.

19. The method of claim 16, further comprising:
transmitting a response message after performing the AIoT operation; and
switching from the second operation state associated with the AIoT operation to a third operation state associated with the AIoT operation after transmitting the response message.

20. A method performed by a reader device, the method comprising:
receiving an operation request message that includes a target area and a device identifier for an ambient Internet of Things (AIoT) device within the target area,
wherein the device identifier includes information associated with one or more operation modes supported by the AIoT device; and
transmitting, to an AIoT device associated with the identifier, a message associated with performance of an AIoT operation associated with the one or more operation modes supported by the AIoT device.
